(19) United States
(12) Patent Application Publication
(10) Pub. No.: US 2006/0123806 A1
(43) Pub. Date: Jun. 15, 2006

(54) Refrigerator and system of refrigerators

(76) Inventors: Vassil Panayotov Vassilev, Sofia (BG); Assen Markov Todorov, Sofia (BG)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/595,017

(22) PCT Filed: Jun. 18, 2003
(86) PCT No.: PCT/BG03/00028

§ 371 Date: Dec. 16, 2005

(51) Int. Cl. G01K 13/00

(52) U.S. Cl. 62/129

(57) ABSTRACT

The refrigerator and the system are applicable in hotels and chains of hotels. The refrigerator has a high degree of intelligence and is convenience for servicing. The system enhances the efficiency of servicing numerous refrigerators in one or several hotels. The refrigerator R comprises a conventional microprocessor system 1, which by means of a conventional complex two-directional bus 3, is connected to modules for reading, monitoring and controlling various functions of the refrigerators. By means of a buffer 20, the microprocessor's system 1 is connected to sensors, arranged within the refrigerator operation space for detection of the position 21 and the kind, price and expiry date 22 of the contained products. Transponders 23, recognizable by the sensors 22, are positioned onto the products that are supplied to the refrigerator at locations where the sensors 23 are arranged. The system of refrigerators comprises N refrigerators R connected to each other by means of N multi-channel communication lines and to a hotel coordination center 24.

### FIELD OF THE INVENTION

The present invention relates to a refrigerator and a system of refrigerators applicable in customary equipment and in particular of hotels and chains of hotels.

### PRIOR ART

A conventional hotel refrigerator of the “mini-bar” type is known, which is arranged in a hotel room and is supplied with beverages and products to be consumed. An authorized employee of the hotel periodically or upon necessity examines whether and how many products are missing from the refrigerator because they were consumed by the guest who stayed in the room, or were stolen, or because of other reasons. The same employee should summarize the data, deliver information about the consumed products so that they are included in the bill of the respective guest, give information about the necessary beverages and products so that the refrigerator is re-supplied, replace the beverages and products with expired date, etc. The employee can come upon possible errors in the proper maintenance of the refrigerator, such as a door left open, but only during examination of the refrigerator. The same thing applies for possible technical failures in the refrigerator, which are noticed by the staff of the hotel with delay during the examination of the contents of the refrigerator. The number of refrigerators in a modern hotel or chain of hotels is significant and requires numerous staff to service the refrigerators.

A disadvantage of the known refrigerator is that it has zero degree of intelligence, it is clumsy and has low servicing efficiency.

No system of refrigerators is known in which the refrigerators are connected in a common data control network.

The object of the present invention is to provide an intelligent refrigerator able to operate in hierarchical data control systems, allowing optimization of its operation and servicing.

Another object of the invention is to provide a data control system consisting of intelligent refrigerators.

### TECHNICAL DESCRIPTION OF THE INVENTION

The object of the present invention is achieved by providing a refrigerator with a conventional microprocessor system with power supply. By means of a conventional complex two-directional bus containing conventional sub-buses for data, controlling and addressing, the microprocessor system is connected to: a module for measuring the temperature, whose two data inputs are connected respectively to a temperature sensor, arranged in the operating space of the refrigerator for measuring the temperature therein, and a temperature sensor arranged adjacent to the compressor or the heater of the refrigerator evaporator for monitoring the normal refrigerator cooling mode; a module for power supply control of the lamp in the refrigerator operating space; a module for power supply control of the compressor or heater of the evaporator of the refrigerator; a module with electronic switch for detecting the “open-closed” position of the refrigerator door; a socket for identification of the coded cards or refrigerator access chips of the authorized user or staff; a sound indicator; a controllable refrigerator door lock; light indicators; multi-linear display; keyboard; multi-channel transceiver module; module for refrigerator power supply monitoring and control and a module for controlling a refrigerator door closure mechanism in case of a failure. By means of a buffer, the microprocessor system is connected to sensors arranged within the refrigerator operation space and intended for detection of the position, kind, price and expiry date of the contained products. The microprocessor module, the power supply, the temperature measuring module, the module for the power supply control of the refrigerator lamp, the module for the power supply control of the compressor or heater, the sound indicator, the multi-channel transceiver module, the module for the power supply monitoring and control, the module for controlling the door closure mechanism in case of a failure and the buffer are arranged in a closed outer unit on the back wall of the refrigerator. The light indicators, the multi-linear display and the keyboard are positioned at a suitable and accessible place within the refrigerator so that they are easily visible upon opening of the refrigerator door. Transponders, which are recognizable by the sensors for the product kind, price and expiry date, are positioned onto the products that are supplied to the refrigerator at locations where the sensors are arranged.

It is possible to arrange the light indicators, the multi-linear display and the keyboard at a suitable and accessible place on the frame of the refrigerator door so that they are easily visible when the refrigerator door is closed.

The sensors for the product position, kind, price and expiry date may form a unified microwave transceiver arranged outside the refrigerator operating space and the transponders may be passive transceivers.

A system S1 of refrigerators is also provided according to the present invention comprising N refrigerators R connected to each other by means of N multi-channel communication lines and to a hotel coordination center consisting of a multi-channel transceiver module connected to a conventional central microprocessor system which is linked to a controlling server. The connection between the refrigerators R and the hotel coordination center is of the star or linear type, or the hierarchical or mixed type.

One or several of the microprocessor systems of the refrigerators R in the system S1 of refrigerators may also function as bi-directional collector-retransmitters of data obtained from particular groups of other refrigerators R for each microprocessor system and of data obtained from the hotel coordination center.

A system S2 of refrigerators is also provided according to the invention comprising M systems S1 of refrigerators connected to one another by means of M multi-channel communication lines and to a main coordination center, which consists of a multi-channel transceiver module connected to a conventional central microprocessor system linked to a controlling server. The main coordination center is connected bi-directionally to data blocks situated at product suppliers, in one's own storehouses, in the transportation facilities and repair bases. It is also connected to global and local data networks, the connection between all the components of the system S2 and the main coordination center is of the star or linear type, or the hierarchical or mixed type.

One or several of the coordination centers of the hotels H within the system S2 of refrigerators may also function as bi-directional collector-retransmitters of data obtained from particular groups of other hotels H for each coordination center and of data obtained from the main coordination center.

An advantage of the refrigerator is that it has a high degree of intelligence and due to this it is convenient and of high servicing efficiency. It is also connected in a data control network of intelligent refrigerators.

An advantage of the system of refrigerators is that it enhances the efficiency of servicing a great number of refrigerators.

### DESCRIPTION OF THE FIGURES

The present invention is described in more detail through an example of carrying out the refrigerator and the system of refrigerators shown in the accompanying figures, wherein:

FIG. 1 is a block diagram of the refrigerator;

FIGS. 2.1, 2.2 and 2.3 are views of an open refrigerator;

FIG. 3 is a diagram of a star-like system of refrigerators;

FIG. 4 is a diagram of a linear system of refrigerators;

FIG. 5 is a diagram of a hierarchical system of refrigerators;

FIG. 6 is a diagram of a mixed system of refrigerators;

FIG. 7 is a diagram of a system of refrigerators with bi-directional collector-retransmitters;

FIG. 8 is a diagram of a system comprising systems of refrigerators.

### EXAMPLE OF CARRYING OUT THE INVENTION

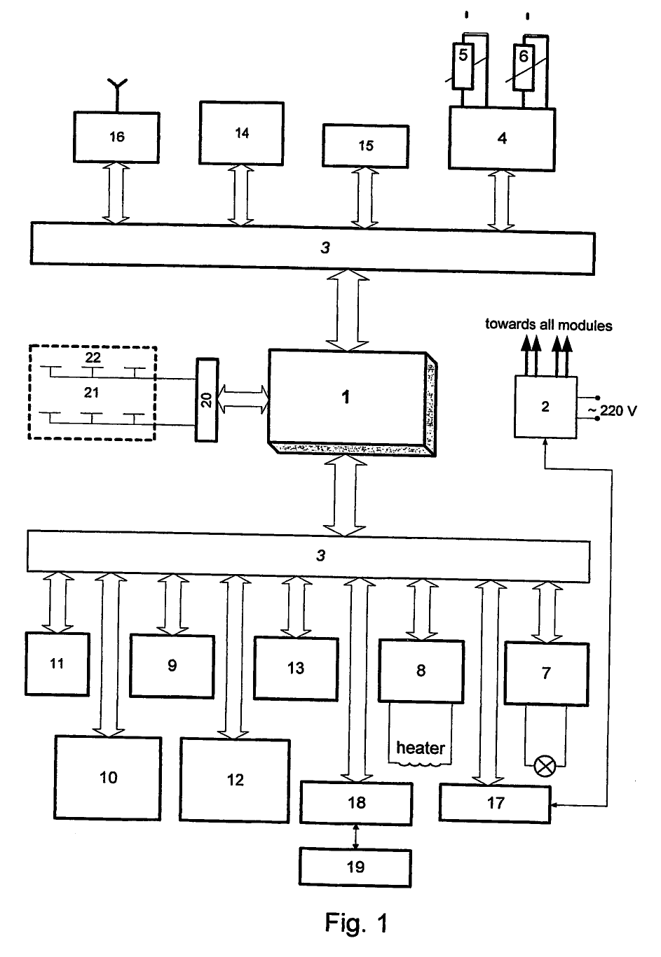

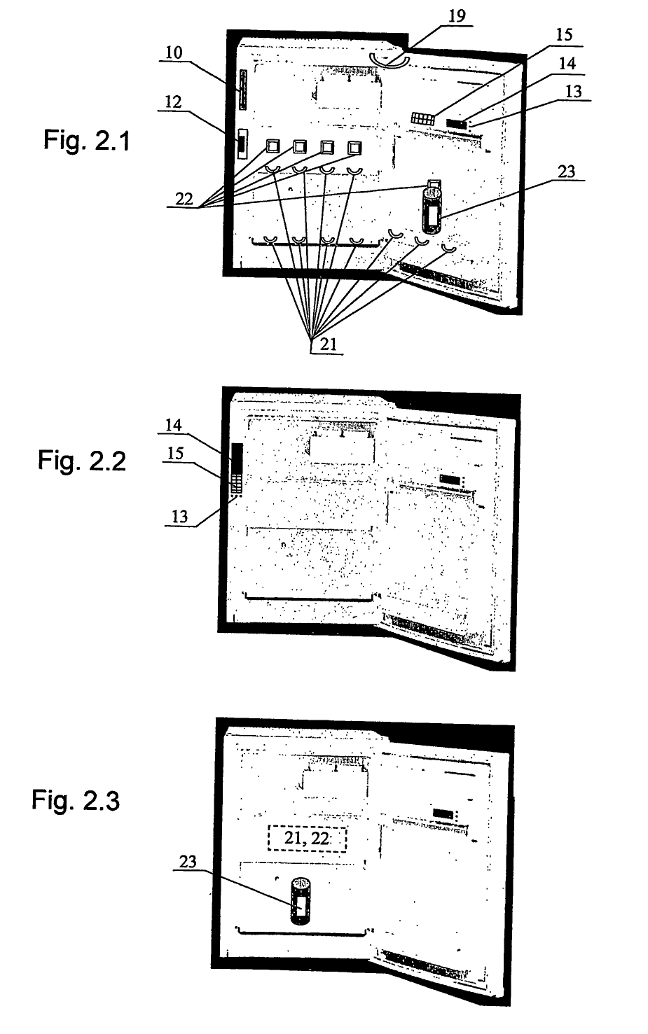

The refrigerator R, shown in FIG. 1 and FIG. 2, comprises a conventional microprocessor system 1 with power supply 2. By means of a conventional complex two-directional bus 3, which contains conventional data, controlling and addressing sub-buses, the microprocessor system 1 is connected to: a module for measuring the temperature 4, whose two data inputs are connected respectively to a temperature sensor 5 arranged in the operating space of the refrigerator for measuring the temperature therein, and to a temperature sensor 6, arranged adjacent to the compressor or the heater of the refrigerator evaporator, for monitoring the normal refrigerator cooling mode; a module 7 for power supply control of the lamp in the refrigerator operating space; a module 8 for power supply control of the compressor or beater of the evaporator of the refrigerator; a module 9 with electronic switch for detecting the “open-closed” position of the refrigerator door; a socket 10 for identification of the coded cards or refrigerator access chips of the authorized user or staff; a sound indicator 11; a controllable refrigerator door lock 12; light indicators 13; multi-linear display 14; keyboard 15; multi-channel transceiver module 16; module 17 for refrigerator power supply monitoring and control and a module 18 for controlling a refrigerator door closure mechanism 19 in case of a failure. By means of a buffer 20, the microprocessor system 1 is connected to sensors arranged within the refrigerator operation space and intended for detection of the position 21 and the kind, price and expiry date 22 of the contained products. The microprocessor module 1, the power supply 2, the temperature measuring module 4, the module 7 for the power supply control of the refrigerator lamp; the module 8 for the power supply control of the compressor or heater, the sound indicator 11, the multi-channel transceiver module 16, the module 17 for the power supply 2 monitoring and control, the module 18 for controlling the door closure mechanism 19 in case of a failure and the buffer 20 are arranged in a closed outer unit on the back wall of the refrigerator. The light indicators 13, the multi-linear display 14 and the keyboard 15 are positioned at a suitable and accessible place within the refrigerator so that they are easily visible upon opening of the refrigerator door. Transponders 23, recognizable by the sensors 22, are positioned onto the products that are supplied to the refrigerator at locations where the sensors 23 are arranged.

It is possible to arrange the light indicators 13, the multi-linear display 14 and the keyboard 15 at a suitable and accessible place on the frame of the refrigerator door so that they are easily visible when the refrigerator door is closed (FIG. 2.2).

The sensors for the product position 21 and those for the product kind, price and expiry date 22 may form a unified microwave transceiver arranged outside the refrigerator operating space and the transponders 23 may be passive transceivers (FIG. 2.3).

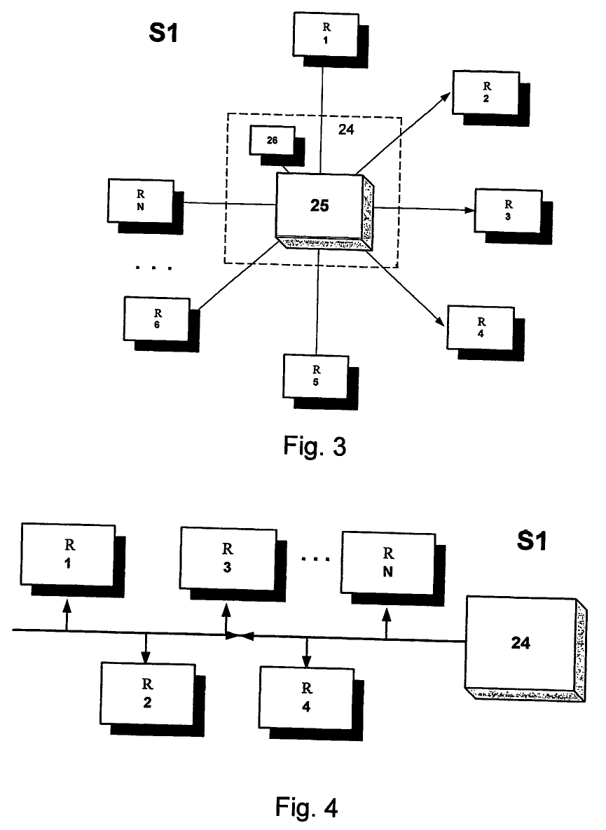

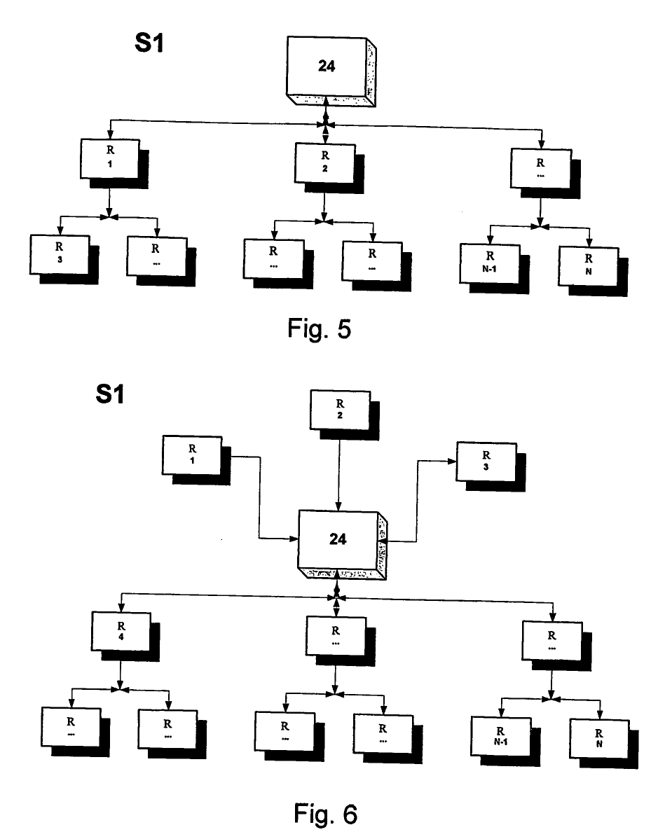

A system S1 of refrigerators is also provided, comprising N refrigerators R connected to each other by means of N multi-channel communication lines and to a hotel coordination center 24 consisting of a multi-channel transceiver module 25 connected to a conventional central microprocessor system 26 which is linked to a controlling server 27. The connection between the refrigerators R and the hotel coordination center 24 is star-like (FIG. 3) or linear (FIG. 4), or hierarchical (FIG. 5) or mixed (FIG. 6).

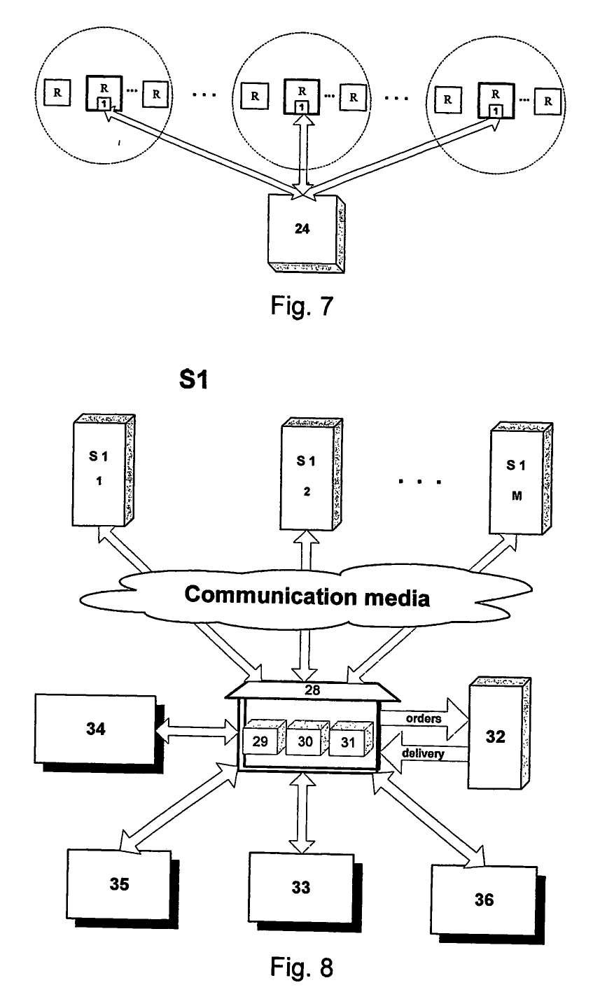

One or several of the microprocessor systems 1 of the refrigerators R in the system S1 of refrigerators may also function as bi-directional collector-retransmitters of data obtained from particular groups of other refrigerators R for each microprocessor system 1 and of data obtained from the hotel coordination center 24 (FIG. 7).

A system S2 of refrigerators is also provided, which comprises M systems S1 of refrigerators connected to one another by means of M multi-channel communication lines and to a main coordination center 28, which consists of a multi-channel transceiver module 29 connected to a conventional central microprocessor system 30 linked to a controlling server 31. The main coordination center 28 is connected bi-directionally to data blocks situated at product suppliers 32, in one's own storehouses 33, in the transportation facilities 34 and at a repair base 35. It is also connected to global and local data networks 36, the connection between all the components of the system S2 and the main coordination center 28 is star-like or linear, or hierarchical or mixed.

One or several of the coordination centers 24 of the hotels H within the system S2 of refrigerators may also function as bi-directional collector-retransmitters of data obtained from particular groups of other hotels H for each coordination center 24 and of data obtained from the main coordination center 28.

### OPERATION AND APPLICATION OF THE INVENTION

The refrigerator operates as follows: When the block 2 is in the ON position it supplies all modules with power. The microprocessor system 1 perceives all the information coming from the modules, and in particular: from the module for measuring the temperature 4, whose two data inputs are connected respectively to the temperature sensor 5 arranged in the operating space of the refrigerator in order to measure the temperature therein, and to the temperature sensor 6 arranged adjacent to the compressor or the heater of the refrigerator evaporator for monitoring the normal refrigerator cooling mode; from the module 9 with an electronic switch for detecting the “open-closed” position of the refrigerator door; from the socket 10 for identification of the coded cards or refrigerator access chips of the authorized user or staff; from the keyboard 15; from the multi-channel transceiver module 16; from the module 17 for refrigerator power supply monitoring and control; through the buffer 20, from the sensors arranged within the refrigerator operation space for detection of the position 21 and the kind, price and expiry date 22 of the contained products. On the basis of this information the microprocessor system 1 generates and sends commands towards the following modules: the module 7 for the power supply control of the lamp in the refrigerator operating space; the module 8 for the power supply control of the compressor or heater of the evaporator of the refrigerator; the sound indicator 11; the controllable refrigerator door lock 12; the light indicators 13; the multi-linear display 14; the multi-channel transceiver module 16; the module 18 for controlling the refrigerator door closure mechanism 19 in case of a failure.

The commands are generated depending on the state of the respective refrigerator R: commands for its normal functioning as well as for the degree to which the refrigerator is supplied with the respective products, the state of these products in terms of their kind, price and expiry date. Under normal state it is meant that the door of the switched on refrigerator has not remained open for more than 2 to 5 min.

The degree of intelligence of the refrigerator and its circuit solution allow the control of the following events:

The refrigerator can only be opened with a card-key of the guest, a mother card of the supplier or technician, a chip-card or a chip-key (not shown in the figures). This card or chip is inserted into the socket 10 for identification. After the socket 10 has read the data contained in the card or the chip, the socket 10 passes the data to the microprocessor system 1. If the card or the chip has an authorized access, the microprocessor system 1 sends a signal to the controllable door lock 12 and it unlocks. In this way the authorized person opens the refrigerator door and is given access to the interior of the refrigerator;

Depending on the access code written on the card or chip the following operation modes are permitted: service mode for supplying the refrigerator with products; service mode for repair and maintenance of the refrigerator; client access mode allowing consumption; refrigerator stock inspection mode;

During the service mode for supplying the refrigerator with products the following operations are performed:

Upon the initial supplying of the refrigerator, the supply staff position the products at their respective locations where the sensors for the product position 21 and those for the product kind, price and expiry date 22 are arranged (FIG. 1 and FIG. 2). During the next supplying the supplier checks the regularity of the packages and the expiry date of the products. In case of necessity the supplier replaces the irregular products with regular products. Then he closes the refrigerator door, takes out the mother card from the socket 10 and thus blocks the door opening and starts the automatic check program in initial regime. The microprocessor system 1 scans the product positions and checks whether the refrigerator is correctly and fully loaded by the supply staff. In case of a mistake the microprocessor system 1 registers the type of mistake, the exact time and the code of the supplier who has made the mistake. These data are stored in the memory of the microprocessor system 1.

The service mode for repair and maintenance of the refrigerator is activated when a conventional subprogram for refrigerator self-diagnosis, which is started either periodically or at the occurrence of a defect in the refrigerator, registers some failure, such as a break off of the heater of the evaporator, a door left open for a continuous period of time, weakened power supply, a defect in the sensor 21 or 22, erroneous defrosting, etc. Then a respective message for the particular defect appears on the refrigerator display 14 and, via the communication network, it is sent to the server and then to the technicians' office. In this mode the technician is given permission for access by inserting his personal coded chip or card into the identification socket 10. After he has repaired the defect he takes out his coded chip or card from the identification socket 10 and thus the normal operational mode starts automatically.

The client access mode allowing consumption is activated when the client inserts his coded card or chip into the identification socket 10. If the card is inserted in a correct manner the microprocessor system 1 recognizes the initials of the client and permits the electronic door lock 19 to be unlocked. When the client opens the refrigerator door a suitable inscription in the respective language appears on the display saying, for example “Welcome! Please select the product you wish”. The client takes a product from some of the available positions and on the display appears the inscription “You selected an orange juice, which costs 1 leva. In case you do not put back the product at its original place until 5-15 seconds, it will be added to your bill”. If the product is not put back at its proper place in the refrigerator within the permitted browsing time limit (5-15 sec.) or if the client closes the refrigerator door, the microprocessor system 1 registers this product as sold. The display 14 displays the following inscription “Orange juice for 1 leva calculated. The subtotal is 1 leva.” If the client takes out two or more products simultaneously the display 14 consecutively displays the product names and prices, the same conditions applying as for a singular product. If the client returns the product at its proper position within the browsing time limit no sale is realized. When a sale is realized the microprocessor system 1 blocks the respective position in the refrigerator, from which the product has been taken. In case the client fills this position with another product brought from outside the hotel, the microprocessor module 1 will not register it because the originally loaded product in this position has already been consumed and calculated. In this way the possibility that the client may replace the products with products brought from outside or the possibility to simulate lack of consumption is cut off. In the meantime, the client can cool his own products brought from outside but only at the already emptied positions. Every sale as well as the exact time at which it was realized is stored in the memory of the refrigerator microprocessor system 1. Upon a request made from the system server, this data is transferred to the common database stored in the server memory. The data stored in the server is processed and upon necessity it is used for the following: preparing an invoice for the respective client when he is leaving the hotel; monitoring the preferred product consumption of the client and refrigerator re-supplying according to an individual scheme; automatic preparation of orders and sending these orders to the storehouses or to the delivery systems; consumption planning and building up a common storehouse unit for hotel chains.

In the client access mode allowing consumption it is possible to monitor the following: the expiry date of the drinks and products in the refrigerator; the quantity and kind of products available in the refrigerator; the presence of unregulated objects in the refrigerator, including drinks and products.

In this mode the client is able to check on the display 14, which is mounted outside the operating space in the side refrigerator wall (FIG. 2.2), what kinds of products are available in the refrigerator and their price by using the keyboard 15 under the display 14 to read the menu. It is possible that a group of refrigerators has an identical menu and another group may have a different menu. The use of an individual menu is also possible.

For this purpose each product is marked at a particularly defined place before it is put in the refrigerator. This is effected by means of a conventional electronically readable transponder 23 (FIG. 2.3), in which the necessary product data is preliminarily entered. The positions for the products in the refrigerator are provided with sensors 21 and 22. When the product is put in the respective position, the sensors 21 and 22 recognize the product data and by means of their connection to the refrigerator microprocessor system 1 they provide this data for use in the refrigerator and respectively, the system of refrigerators. A system is also provided where the sensors 21 and 22 are unified into a single common transceiver, shown in broken lines in FIG. 2.3, which is fitted outside the refrigerator operating space. Via a radio channel the transceiver activates the passive transponders 23 (flexible intelligent labels) attached to the products and reads the preliminarily written data about the product kind, price and expiry date.

In the refrigerator according to the invention it is possible to monitor for wrong operation and maintenance of the refrigerator as well as for possible failures that may occur. For this purpose, the main refrigerator units such as the aggregate, the door, the power supply, etc., are provided with suitable state sensors connected to the refrigerator microprocessor system 1.

It is also possible to remotely control the refrigerator during its operation and in cases of failures. For this purpose, respective controlling outputs of the microprocessor are connected to the performance components of the refrigerator, such as the inner temperature regulator, the power supply, door closure, etc.

It is further possible to connect the refrigerators to the server and to one another by means of all kinds of communication channels such as radio communication, cable communication, optical communication, etc. For this purpose, each refrigerator is provided with the necessary transceiver devices.

The protocol of the connection consists of typical algorithmic modules, which are modified according to the concrete application and guarantee authenticity of the received data by means of noise reduction codes, time-dividing mode of operation, control as per the parameters of the transmitted, and respectively received data, and suitably designed set of commands.

The refrigerators R, described above, can be connected (FIG. 3, FIG. 4, FIG. 5, FIG. 6) to each other by means of N multi-channel communication lines and to a hotel coordination center 24, consisting of a multi-channel transceiver module 25 connected to a conventional central microprocessor system 26. Depending on the connection to the server, the system of refrigerators can have one of the following structures: star-like (FIG. 3), linear (FIG. 4), hierarchical (FIG. 5) or mixed (FIG. 6). Each of these structures permits, upon necessity, the use of one or several of the refrigerators not only for their usual functions, but also as a repeater 1 of data obtained from other refrigerators (FIG. 7). This is necessary when a given refrigerator is so far away that the server 24 does not have a direct radio communication with it. In such cases the server remotely starts a program in a nearer refrigerator and assigns to this refrigerator the functions of a repeater 1. The repeater 1 connects to the refrigerator R which is out of the reach of the server and when the repeater 1 obtains the necessary data from the refrigerator R, it summarizes this data and sends it together with his own data to the server. In the system S1 of refrigerators the server 24 consecutively enquires the refrigerators about changes that may have occurred in their proper state. In case of a positive answer, the server 24 reads the data stored in the database of the microprocessor system 1 of the refrigerator, processes this data and generates its own database. This database is used for the preparation of various references, summaries and commands intended for the system servicing staff or team.

In case of a failure in a refrigerator, the message for this failure is sent and processed by the server with priority.

Via the communication channel, the server remotely sends data to every refrigerator about its menu and it is recorded into the database of the respective refrigerator microprocessor system 1. The menu contains data about each product position, kind and price.

Also, via the communication channel, the server remotely sends data to every refrigerator for the sum, owed by the client for the time being.

The stored data files and the basic data about the state of each refrigerator R within the system S1 is stored in the database of the server 24. On the basis of this database the following references can be prepared: invoice for the respective client when he is leaving the hotel; visualization of the state of the refrigerator by means of the monitor of the operator or the hotel reception-room staff; monitoring the preferred product consumption of the client and refrigerator re-supplying according to an individual scheme; automatic preparation of orders and sending these orders to the storehouses or the delivery systems; necessary repairs; consumption planning and building up a common storehouse unit for hotel chains.

By means of respective communication channels, the system of refrigerators is able to communicate independently with supply units, repair and service teams, anti-fire systems, etc. in order to properly maintain the supplies and the good working order of the refrigerators.

A higher level of integration of functions is achieved by creating a common system S2 of refrigerators consisting of M number of systems S1 of refrigerators. In the system S2, M systems S1 of refrigerators are connected to one another by means of M multi-channel communication lines and to a main coordination center 28. The main coordination center 28 integrates in its structure a multi-channel transceiver module 29, a conventional central microprocessor system 30 and a controlling server 31. The main coordination center 28 is connected bi-directionally to data blocks situated at the product suppliers 32, in one's own storehouses 33, in the transportation facilities 34 and at a repair base 35. It is also connected to global and local data networks 36, the type of connection between all the components of the system S2 and the main coordination center 28 is star-like (FIG. 8), or linear, or hierarchical or mixed.

A database about the state and the archived changes that have occurred in each individual system S1 of refrigerators is generated in the main coordination center 28. The summarizing of the data in 28 permits centralized analysis of the state of each system S1 and a timely reaction within the system S2 by means of the following: ordering and delivery of the necessary products and spare parts to 32; establishing one's own storehouses 33; centralized dispatching control of transport 34 within the system; ordering and monitoring repairs—35; development of statistical analyses and evaluations.

The connection of the main coordination center 28 to global and local networks 36 provides integration of the database as well as summarizing of data about a multitude of systems S2 within a chain of hotels in two or more countries.

1. A refrigerator R characterized in that it comprises a conventional microprocessor system 1 with power supply 2 and by means of a conventional complex two-directional bus 3, which contains conventional data sub-buses, controlling and addressing sub-buses, the microprocessor system 1 is connected to: a module for measuring the temperature 4, whose two data inputs are connected respectively to a temperature sensor 5 arranged in the operating space of the refrigerator for measuring the temperature therein, and to a temperature sensor 6 arranged adjacent to the compressor or the heater of the refrigerator evaporator in order to monitor the normal refrigerator cooling mode; a module 7 for power supply control of the lamp in the refrigerator operating space; a module 8 for power supply control of the compressor or heater of the evaporator of the refrigerator; a module 9 with electronic switch for detecting the “open-closed” position of the refrigerator door; a socket 10 for identification of the coded cards or refrigerator access chips of the authorized user or staff; a sound indicator 11; a controllable refrigerator door lock 12; light indicators 13; multi-linear display 14; keyboard 15; multi-channel transceiver module 16; module 17 for refrigerator power supply monitoring and control, and a module 18 for controlling a refrigerator door closure mechanism 19 in cases of failures, and the microprocessor system 1 is connected, by means of a buffer 20, to sensors arranged within the refrigerator operation space and intended for detection of the position 21 and the kind, price and expiry date 22 of the contained products, whereupon the microprocessor module 1, the power supply 2, the temperature measuring module 4, the module 7 for the power supply control of the refrigerator lamp, the module 8 for the power supply control of the compressor or heater, the sound indicator 11, the multi-channel transceiver module 16, the module 17 for monitoring and control of the power supply 2, the module 18 and the buffer 20 are arranged in a closed outer unit on the back wall of the refrigerator, and the light indicators 13, the multi-linear display 14 and the keyboard 15 are positioned at a suitable and accessible place within the refrigerator so that they are easily visible upon opening of the refrigerator door, whereupon transponders 23, recognizable by the sensors 22, are positioned onto the products which are supplied to the refrigerator at locations where the sensors 23 are arranged.

2. The refrigerator R according to claim 1 characterized in that the light indicators 13, the multi-linear display 14 and the keyboard 15 are positioned at a suitable and accessible place on the frame of the refrigerator door which is easily visible when the refrigerator door is closed.

3. The refrigerator R according to claim 1 characterized in that the sensors for the product position 21 and the sensors for the product kind, price and expiry date 22 form a unified microwave transceiver arranged outside the refrigerator operating space and the transponders 23 are passive transceivers.

4. A system S1 of refrigerators according to claim 1 characterized in that it comprises N refrigerators R connected to each other by means of N multi-channel communication lines and to a hotel coordination center 24 consisting of a multi-channel transceiver module 25 connected to a conventional central microprocessor system 26 which is linked to a controlling server 27, the type of connection between the refrigerators R and the hotel coordination center 24 is star-like, linear, hierarchical or mixed.

5. The system S1 of refrigerators according to claim 4 characterized in that one or several of the microprocessor systems 1 of the refrigerators R function as bi-directional collector-retransmitters of data obtained from particular groups of other refrigerators R for each microprocessor system 1 and of data obtained from the hotel coordination center 24.

6. A system S2 of refrigerators characterized in that it comprises M systems S1 of refrigerators according to claims 2 and 3 connected to one another by means of M multi-channel communication lines and to a main coordination center 28, which consists of a multi-channel transceiver module 29 connected to a conventional central microprocessor system 30 linked to a controlling server 31, the main coordination center 28 is connected bi-directionally to data blocks situated at product suppliers 32, in one's own storehouses 33, in the transportation facilities 34 and at a repair base 35, and to global and local data networks 36, the type of the connection between all the elements of the system S2 and the main coordination center 28 is star-like or linear, or hierarchical or mixed.

7. The system S2 of refrigerators according to claim 6 characterized in that one or several of the coordination centers 24 of the hotels H function as bi-directional collector-retransmitters of data obtained from particular groups of other hotels H for each coordination center 24 and of data obtained from the main coordination center 28.
